(19) United States
(12) Patent Application Publication
(10) Pub. No.: US 2010/0021222 A1
(43) Pub. Date: Jan. 28, 2010

(54) MEMBRANE CABLE AND KEYBOARD

(75) Inventors: Kan Ping Lo, Taoyuan (TW); Wen Yu Tsai, Taoyuan (TW); Yun Nien Chai, Taoyuan (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Darfon Electronics Corp., Taoyuan (TW)

(21) Appl. No.: 12/507,423

(22) Filed: Jul. 22, 2009

(30) Foreign Application Priority Data
Jul. 23, 2008 (TW) 097213131

(51) Int. Cl. B41J 5/00; H02G 3/04

(52) U.S. Cl. 400/472; 174/68.1

(57) ABSTRACT

The invention discloses a membrane cable including several metal wires, a cover body and a reinforcement plate. The cover body covers the metal wires, and the reinforcement plate is adhered to an external surface of the cover body. The cover body and the metal wires are bended toward the reinforcement plate, and the reinforcement plate can prevent the cover body and the metal wires from being over-bended.

### BACKGROUND OF THE INVENTION

1. Field of the Invention

The invention relates to a membrane cable and, more particularly, to a membrane cable applied in a keyboard.

2. Description of the Prior Art

When two separated electronic components or circuit boards need to be linked, a flex printed circuit (FPC) or a membrane cable can be utilized to carry the needed linking wirings. However, in order to implement the linking wirings on the FPC, the etching process is a must. Besides, the substrate of the FPC is more expensive compared to the membrane cable. On the contrary, the membrane cable needs no extra circuit mold to implement the linking wirings, such that it can reduce the producing cost by adopting the membrane cable.

The membrane cable is a component for signal transmission. The membrane cable, which has advantages in high flexibility and high conductivity, is suitable to be applied in a compact electronic product. In general, the membrane cable is assembled with a pluggable connector for elevating their connectivity and mobility.

Even though, the membrane cable is bendable and compact compared with the traditional wiring, but the membrane cable will be damaged when the membrane cable is over-bended (e.g. suffering too large folding angle). The metal wirings and the isolation portion covering the metal wirings will be damaged on an over-bended membrane cable, so as to cut down the efficiency of the membrane cable.

In general, the bending process on the membrane cable is done manually, which means manufacturers must bend the membrane cable a little to form a fold line, and then bend the membrane cable to the specification flexure. There are some disadvantages in manual bending process: (1) The bending position cannot be fixed on the membrane cable. The bending position differs from time to time, such that the assembling efficiency is decreased. (2) The bending position must be pressed to a certain degree by hands for forming an obvious fold line and angle. The pressing force is hard to control. In this case, a crack or a fracture may appear around the bending position of the membrane cable, such that the producing yield rate of the membrane cable will be decreased.

Therefore, the invention discloses a membrane cable with a reinforcement plate, so as to solve the fracture problem and the bending process issue.

### SUMMARY OF THE INVENTION

A scope of the invention is to provide a membrane cable, which is free from being over-bended, and a bending position of the membrane cable can be defined easily.

According to a first embodiment, the membrane cable of the invention includes metal wires, a cover body and a first reinforcement plate. The cover body covers the metal wires. The first reinforcement plate is adhered to an external surface of the cover body. The cover body and the metal wires are bended toward the first reinforcement plate. Accordingly, the bending pattern of the cover body will be blocked by the reinforcement plate, so that it cannot reach the maximum folding angle before attaching the reinforcement plate. In other words, the reinforcement plate restricts the maximum folding angle and reduces the possibility of the bending fracture.

In a second embodiment, the external surface of the cover body includes an upper surface and a lower surface opposite to the upper surface. The membrane cable further includes a second reinforcement plate and a third reinforcement plate, both of which are printed on the external surface of the cover body. The first reinforcement plate, the second reinforcement plate and the third reinforcement plate are adhered to the same surface (the upper surface or the lower surface). Besides, the second reinforcement plate and the first reinforcement plate are separated by a first mark line between them. The third reinforcement plate and the first reinforcement plate are separated by a second mark line between them.

Accordingly, when the membrane cable is bended, the first reinforcement plate will contact the second reinforcement plate or the third reinforcement plate, so as to restrict the maximum folding angle and reduce the possibility of the bending fracture.

In a third embodiment, the first reinforcement plate is adhered to the upper surface, while the second and the third reinforcement plate are both adhered to the lower surface. Accordingly, each surface has at least one reinforcement plate attached. Therefore, the membrane cable is not limited to one bending direction. Instead, the membrane can be bended in direction of the upper surface or the lower surface.

Another scope of the invention is to provide a keyboard, which has a membrane cable. The membrane cable is free from being over-bended, and a bending position of the membrane cable can be defined easily.

According to an embodiment, the keyboard of the invention includes a keyswitch, a membrane circuit board and a membrane cable. The membrane circuit board is located below the keyswitch. The membrane cable is electrically connected to the membrane circuit board. The details about the membrane cable are mentioned in previous descriptions, and are not repeated here.

In summary, the invention utilizes mark lines to define bending positions. In this way, the manufacturers may bend the membrane cable according to the mark lines. It helps to increase yield rate, speed up the assembling process and reduce errors in trying to locate the bending position. Besides, the invention utilizes the reinforcement plates adhered closely onto the cover body to reduce the maximum folding angle and help locating the bending position. Accordingly, the reinforcement plates may prevent the fracture problem, caused by over folding angle or excessive bending times, of the cover body and the metal wires. Therefore, the invention solve the problem that too large folding angle may break the cover body, and also solve the cover body damage issue caused by that the bending position is hard to defined in producing process.

The advantage and spirit of the invention may be understood by the following recitations together with the appended drawings.

### BRIEF DESCRIPTION OF THE APPENDED DRAWINGS

FIG. 1 is an exploded view illustrating a keyboard according to a first embodiment of the invention.

FIG. 2A is a schematic diagram illustrating the membrane cable in FIG. 1 before the bending action.

FIG. 2B is a schematic diagram illustrating the membrane cable in FIG. 1 after the bending action.

FIG. 3 is a schematic diagram illustrating a membrane cable according to a second embodiment of the invention.

FIG. 4 is a schematic diagram illustrating a membrane cable according to a third embodiment of the invention.

### DETAILED DESCRIPTION OF THE INVENTION

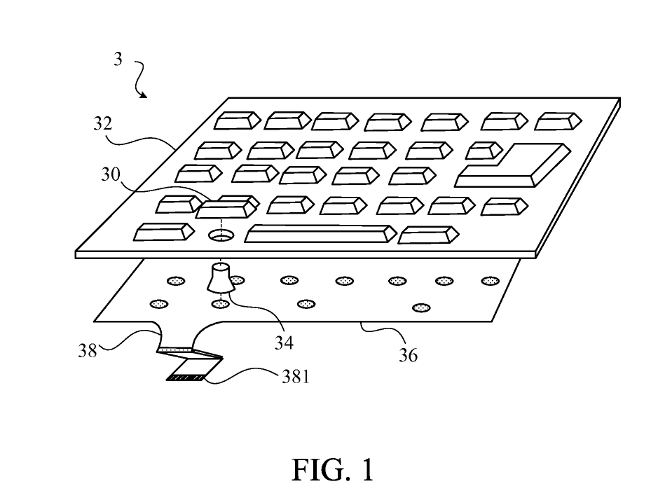

Please refer to FIG. 1. FIG. 1 is an exploded view illustrating a keyboard 3 according to a first embodiment of the invention. As shown in FIG. 1, the keyboard 3 of the invention includes keyswitches (including keyswitch 30), a substrate 32, a membrane circuit board 36 and a membrane cable 38. The keyswitches 30 is located above the substrate 32 and connected to the substrate 32. There are through holes disposed on the substrate 32. Each through holes corresponds to one of the keyswitches 30 and accommodates a flexible body 34. The membrane circuit board 36 is located below the substrate 32. The flexible body 34 is located on the membrane circuit board 36. When users press the keyswitch 30, the keyswitch 30 is forced to push the flexible body 34. Accordingly, the flexible body 34 is forced to push the membrane circuit board 36. One switching circuit of the membrane circuit board 36 will be switched on because of the pressing, so as to generate the electronic signal corresponding to the keyswitch 30.

The membrane cable 38 is electrically connected to the membrane circuit board 36. The membrane cable 38 has a connecting terminal 381 for further connecting with some other electronic components (not shown). Therefore, the electronic signal, generated by the membrane circuit board 36, can be transmitted to other electronic components through the membrane cable 38. It must be noted that, in order to prevent the diagram from being too complex to understand, the printed circuit is not shown in the membrane circuit board 36 in FIG. 1, and there is only one flexible body 34 illustrated in the FIG. 1. In practical applications, there is one flexible body and also one corresponding switching circuit under every keyswitches.

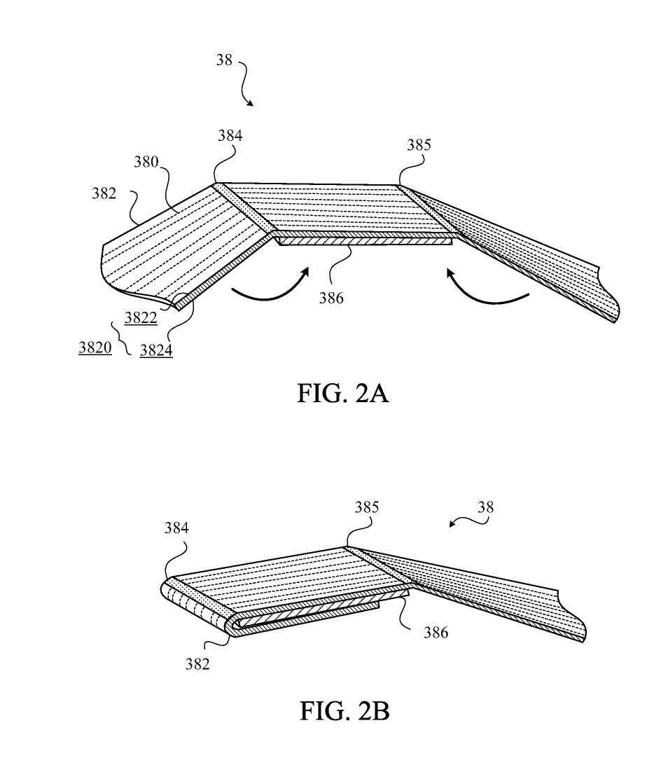

In general, the connecting portion, between the connecting terminal 381 of membrane cable 38 and the membrane circuit board 36, needs a certain length and width for accommodating all circuit wirings corresponding to all the keyswitches on the keyboard 3. Therefore, the membrane cable 38 must be stretched out a certain distance from the membrane circuit board 36. When the connecting port of the electronic component (not shown) is located right beneath the membrane circuit board 36, it is needed for the membrane cable 38 to bend for matching the position of the connecting port. Please refer to FIG. 2A and FIG. 2B for better understanding how the membrane cable of the invention can deal with the fracture problem caused by the bending action.

FIG. 2A is a schematic diagram illustrating the membrane cable 38 in FIG. 1 before the bending action. FIG. 2B is a schematic diagram illustrating the membrane cable 38 in FIG. 1 after the bending action. As shown in FIG. 2A and FIG. 2B, the membrane cable 38 in the invention includes a plurality of metal wires 380, a cover body 382 and a first reinforcement plate 386. The cover body 382 covers the metal wires 380. The first reinforcement plate 386 is adhered to an external surface 3820 of the cover body 382. The cover body 382 and the metal wires 380 are both bended toward the first reinforcement plate 386 (along the arrow direction in FIG. 2A).

In fact, the external surface 3820 of the cover body 382 includes an upper surface 3822 and a lower surface 3824 opposite to the upper surface 3822. The first reinforcement plate 386 is adhered to the lower surface 3824. The first mark line 384 is printed on the upper surface 3822 and substantially aligned with the edge of the reinforcement plate 386. The purpose of the first mark line is to help the manufacturer indefinite the bending position while manually bending the membrane cable 38. In this case, the manufacturer may easily bend the membrane cable 38 toward the first reinforcement plate 386 according to the first mark line 384 printed on the upper surface 3822, so as to reduce the try-and-error attempts for finding the correct bending position. The less attempts of bending the membrane cable 38, the better chance that the cover body 382 and the metal wires 380 can be free from fracture or broken problems.

Besides, when part of the cover body 382 is bended toward the first reinforcement plate 386 (bending inward), the first reinforcement plate 386 with a certain thickness will block the bending pattern of the cover body 382, and also limit the maximum bending angle. Therefore, the first reinforcement plate 386 can prevent the membrane cable 38 from being over-bended.

In addition, the first reinforcement plate 386 has a concrete shape itself. The edge of the first reinforcement plate 386 can be aligned with the first mark line 384. Therefore, besides bending along the first mark line 384, the manufacturer can figure out the correct bending line by touching the edge of the first reinforcement plate 386 while bending the membrane cable 38. In other words, the first reinforcement plate 386 has the utility of positioning the bending line, so that it can help to elevate the assembling speed.

To be noticed that, the cover body 382 and the metal wires 380 in FIG. 1 can only be bended toward the lower surface 3824 on which the first reinforcement 386 is adhered. In this case, there is no reinforcement plate on the upper surface 3822, such that the first reinforcement plate 386 cannot limit the maximum bending angle toward the upper surface 3822, and so it cannot make sure that the membrane cable 38 is free from being over-bended.

There is a second mark line 385 printed on the upper surface 3822 of the cover body 382 in FIG. 1. The first reinforcement plate 386 is adhered between the first mark line 384 and the second mark line 385. Therefore, the membrane cable 38 may also be bended to the first reinforcement plate 386 according to the second mark line 385. Accordingly, the membrane cable 38 in FIG. 1 can be bended to form a reverse U shape.

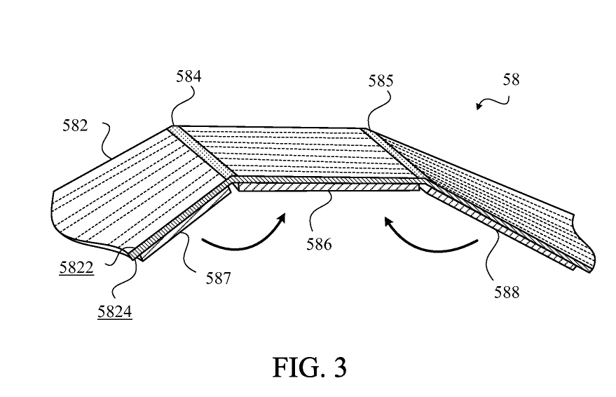

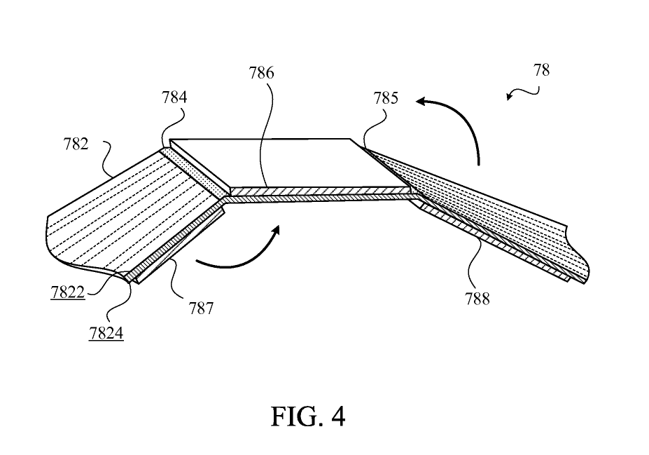

The membrane cable of the invention is not limited to the embodiment shown in FIG. 1. Some other embodiments of the membrane cable of the invention are disclosed in following paragraphs and illustrated in FIG. 3 and FIG. 4.

Please refer to FIG. 3. FIG. 3 is a schematic diagram illustrating a membrane cable 58 according to a second embodiment of the invention. Compared with FIG. 2A and FIG. 2B, the membrane cable 58 in FIG. 3 further includes a second reinforcement plate 587 and a third reinforcement plate 588. The first reinforcement plate 586, the second reinforcement plate 587 and the third reinforcement plate 588 are both adhered to the lower surface 5824 of the cover body 582. The second reinforcement plate 587 and the first reinforcement plate 586 are separated by a first mark line 584. The third reinforcement plate 588 and the first reinforcement plate 586 are separated by a second mark line 585. The first mark line 584 and the second mark line 585 are both printed on the upper surface 5822 of the cover body 582.

Besides, when the membrane cable 58 is bended toward the first reinforcement plate 586 along the first mark line 584 or the second mark line 585, the second reinforcement plate 587 or the third reinforcement plate 588 will contact the first reinforcement plate 586, such that the bending pattern is blocked, and the maximum bending angle is further limited.

Please refer to FIG. 4. FIG. 4 is a schematic diagram illustrating a membrane cable 78 according to a third embodiment of the invention. Compared with FIG. 3, the first reinforcement plate 786 in FIG. 4 is adhered to the upper surface 7822 of the cover body 782. The second reinforcement plate 787 and the third reinforcement plate 788 are both adhered to the lower surface 7824.

In this embodiment, there is at least one reinforcement plate respectively attached on the upper surface 7822 and the lower surface 7824. Therefore, the membrane cable 78 is not limited in one bending direction (toward the upper surface 7822 or toward the lower surface 7824). In other words, the membrane cable 78 in FIG. 4 can be bended in the direction along the arrow in FIG. 4, and it can also be bended in the reverse direction, such that the membrane cable 78 can be applied in various products designed with different bending directions.

In the third embodiment, because the membrane cable 78 is not limited to a specific bending direction, the first mark line 784 and the second mark line 785 are preferable to be printed not only on the upper surface 7822 of the cover body 782 but also on the lower surface 7824 (the mark lines on the lower surface 7824 cannot be illustrated in FIG. 4 because of the viewing angle). In this way, if a manufacturer wants to bend part of the cover body 782, where the third reinforcement plate 788 attached, toward the first reinforcement plate 786, the manufacturer may refer to the second mark line (not shown) printed on the lower surface 7824, saving the effort of flipping the membrane cable 78 to check the second mark line 785 printed on the upper surface 7822. Therefore, printing the mark line on both sides can further increase the efficiency in assembling.

Compared to prior art, the invention utilizes mark lines to define bending positions. In this way, the manufacturers may bend the membrane cable according to the mark lines. It helps to increase yield rate, speed up the assembling process and reduce errors in trying to locate the bending position. Besides, the invention utilizes the reinforcement plates adhered closely onto the cover body to reduce the maximum folding angle and help locating the bending position. Accordingly, the reinforcement plates may prevent the fracture problem, caused by over folding angle or excessive bending times, of the cover body and the metal wires. Therefore, the invention solve the problem that too large folding angle may break the cover body, and also solve the cover body damage issue caused by that the bending position is hard to defined in producing process.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A membrane cable, comprising:
a plurality of metal wires;
a cover body covering the metal wires; and
a first reinforcement plate adhered to an external surface of the cover body;
wherein the cover body and the metal wires are bended toward the first reinforcement plate.

2. The membrane cable of claim 1, further comprising a second reinforcement plate adhered to the external surface of the cover body, the second reinforcement plate and the first reinforcement plate being separated by a first mark line.

3. The membrane cable of claim 2, wherein the external surface of the cover body comprises an upper surface and a lower surface opposite to the upper surface, the first reinforcement plate is adhered to the upper surface, and the second reinforcement plate is adhered to the lower surface.

4. The membrane cable of claim 2, wherein the external surface of the cover body comprises a lower surface, and the first reinforcement plate and the second reinforcement plate are both adhered to the lower surface.

5. The membrane cable of claim 1, further comprising a first mark line and a second mark line, both of which are printed on the external surface of the cover body, the first reinforcement plate being adhered to the external surface between the first mark line and the second mark line.

6. The membrane cable of claim 5, further comprising a second reinforcement plate and a third reinforcement plate, both of which are adhered to the external surface of the cover body, the second reinforcement plate and the first reinforcement plate being separated by the first mark line, the third reinforcement plate and the first reinforcement plate being separated by the second mark line.

7. The membrane cable of claim 6, wherein the external surface comprises an upper surface and a lower surface opposite to the upper surface, the first reinforcement plate is adhered to the upper surface, and the second reinforcement plate and the third reinforcement plate are both adhered to the lower surface.

8. A keyboard, comprising:
a keyswitch;
a membrane circuit board located below the keyswitch; and
a membrane cable electrically connected to the membrane circuit board, the membrane cable comprising:
a plurality of metal wires;
a cover body covering the metal wires; and
a first reinforcement plate adhered to an external surface of the cover body;
wherein the cover body and the metal wires of the membrane cable are bended toward the first reinforcement plate.

9. The keyboard of claim 8, wherein the membrane cable comprises a second reinforcement plate adhered to the external surface of the cover body, and the second reinforcement plate and the first reinforcement plate are separated by a first mark line.

10. The keyboard of claim 9, wherein the external surface of the cover body of the membrane cable comprises an upper surface and a lower surface opposite to the upper surface, the first reinforcement plate is adhered to the upper surface, and the second reinforcement plate is adhered to the lower surface.

11. The keyboard of claim 9, wherein the external surface of the cover body of the membrane cable comprises a lower surface, and the first reinforcement plate and the second reinforcement plate are both adhered to the lower surface.

12. The keyboard of claim 8, wherein the membrane cable comprises a first mark line and a second mark line, both of which are printed on the external surface of the cover body, the first reinforcement plate being adhered to the external surface between the first mark line and the second mark line.

13. The keyboard of claim 12, wherein the membrane cable comprises a second reinforcement plate and a third reinforcement plate, both of which are adhered to the external surface of the cover body, the second reinforcement plate and the first reinforcement plate being separated by the first mark line, the third reinforcement plate and the first reinforcement plate being separated by the second mark line.

14. The keyboard of claim 13, wherein the external surface of the membrane cable comprises an upper surface and a lower surface opposite to the upper surface, the first reinforcement plate is adhered to the upper surface, and the second reinforcement plate and the third reinforcement plate are both adhered to the lower surface.

15. The keyboard of claim 13, wherein the keyswitch comprises:
a keycap;
a substrate located below the keycap; and
a supporting body jointed with the keycap and the base plate, for supporting the keycap to move vertically relative to the substrate.
